(19) United States
(12) Patent Application Publication
(10) Pub. No.: US 2024/0146072 A1
(43) Pub. Date: May 2, 2024

(54) Power Supply System and Method of Controlling Power Supply System

(71) Applicant: TOYOTA JIDOSHA KABUSHIKI KAISHA, Toyota-shi Aichi-ken (JP)

(72) Inventor: Yoshiaki KIKUCHI, Toyota-shi Aichi-ken (JP)

(73) Assignee: TOYOTA JIDOSHA KABUSHIKI KAISHA, Toyota-shi Aichi-ken (JP)

(21) Appl. No.: 18/380,684

(22) Filed: Oct. 17, 2023

(30) Foreign Application Priority Data
Nov. 2, 2022 (JP) 2022-176389

(51) Int. Cl. H02J 7/00; H01M 10/0525; H01M 10/46; H01M 50/51

(52) U.S. Cl. CPC H02J 7/0014; H01M 10/0525; H01M 10/46; H01M 50/51; H02J 2207/20

(57) ABSTRACT

A power supply system is a power supply system that performs charging and discharging between the power supply system and an external system. The power supply system includes a plurality of battery units and a controller. The plurality of battery units include a plurality of battery packs and a plurality of converters provided corresponding to the plurality of battery packs. The plurality of battery units are connected together in parallel. The controller controls the plurality of converters to charge each of the plurality of battery packs to a fully charged state. For each of the plurality of battery packs, the controller is configured to perform equalization control to equalize voltages of cells included in the battery pack when the battery pack is charged to the fully charged state.

This nonprovisional application is based on Japanese Patent Application No. 2022-176389 filed on Nov. 2, 2022 with the Japan Patent Office, the entire contents of which are hereby incorporated by reference.

### BACKGROUND

### Field

The present disclosure relates to a power supply system and a control method of the power supply system, and more particularly, to a power supply system in which a plurality of battery units respectively including a plurality of battery assemblies and converters are connected in parallel to each other, and a control method thereof.

### Description of the Background Art

Japanese Patent Application Laid-Open No. 2014-103804 discloses a technique for equalizing voltages of a plurality of battery assemblies in a battery system in which a plurality of battery assemblies are connected in parallel to each other. Japanese Patent Application Laid-Open No. 2020-60581 discloses a battery having a flat region (voltage flat region) in an OCV (Open Circuit Voltage)-SOC (State Of Charge) characteristic over a wide range.

### SUMMARY

In order to eliminate variation in SOC between a plurality of cells (cells) included in the battery assembly, equalization control for equalizing the voltages of these cells has been known. In the case of the battery having a voltage flat region in the OCV-SOC characteristic as disclosed in Japanese Patent Application Laid-Open No. 2020-60581, there is a possibility that the variation in SOC is not effectively eliminated. This is due to the following reason: even though the equalization control for the cells is performed in the voltage flat region, the SOC is not precisely estimated in the voltage flat region. Therefore, in the case of the battery having the voltage flat region in the OCV-SOC characteristic, it is useful to charge such a battery to a fully charged state and perform equalization control onto the battery in the fully charged state.

However, in the power supply system in which the plurality of battery assemblies are connected to the power conversion device in parallel as in Japanese Patent Application Laid-Open No. 2014-103804, all the battery assemblies cannot be charged to the fully charged state due to a difference in internal resistance between the battery assemblies or the like.

It is an object of the present disclosure to provide a power supply system including a plurality of battery assemblies connected together in parallel, so as to charge all the battery assemblies to a fully charged state and perform equalization control onto the battery assemblies in the fully charged state.

A power supply system of the present disclosure is a power supply system that performs charging and discharging between the power supply system and an external system. The power supply system includes: a plurality of battery units including a plurality of battery assemblies and a plurality of converters provided corresponding to the plurality of battery assemblies; and a controller that controls the plurality of battery units. The plurality of battery units are connected together in parallel. The controller controls the plurality of converters to charge each of the plurality of battery assemblies to a fully charged state, and for each of the plurality of battery assemblies, performs equalization control to equalize voltages of cells included in the battery assembly when the battery assembly is charged to the fully charged state.

According to this configuration, each of the battery units includes the battery assembly and the converter. The plurality of battery units are connected together in parallel. Since each of the battery units includes the battery assembly and the converter, the converter can be used to control charging and discharging of the battery assembly corresponding to the converter. By controlling the converter, the corresponding battery assembly can be charged to the fully charged state. The controller that controls the plurality of battery units controls the plurality of converters so as to charge each of the plurality of battery assemblies to the fully charged state, and for each of the plurality of battery assemblies, performs the equalization control to equalize the voltages of the cells included in the battery assembly when the battery assembly is charged to the fully charged state. Thus, each of the battery assemblies can be charged to the fully charged state, and the equalization control for equalizing the voltage of the cell of the battery assembly can be performed in the fully charged state.

In some embodiments, for each of the plurality of battery assemblies, the controller controls a converter that corresponds to the battery assembly so as to charge the battery assembly to the fully charged state whenever a predetermined period has elapsed since the battery assembly is charged to the fully charged state the last time. This makes it possible to equalize the voltages of the cells included in the battery assembly at an appropriate interval by setting the predetermined period. The predetermined period is set, for example, based on variation in amount of self-discharging of the cells or variation in impedance of the voltage detection circuit. The predetermined period is, for example, 30 days.

In particular, when the battery assembly includes a plurality of cells connected in series and each cell is an iron-phosphate-based lithium ion battery (LFP battery), a voltage flat region exists in the OCV-SOC characteristic. Therefore, it is effective to charge the battery assembly to the fully charged state and equalize the voltages of the cells included in the battery assembly in the fully charged state.

A control method of the present disclosure is a method of controlling a power supply system that performs charging and discharging between the power supply system and an external system. The power supply system includes a plurality of battery units respectively including a plurality of battery assemblies and a plurality of converters. The plurality of battery units are connected together in parallel. The method includes: controlling the plurality of converters to charge each of the plurality of battery assemblies to a fully charged state; and for each of the plurality of battery assemblies, performing equalization control to equalize voltages of cells included in the battery assembly when the battery assembly is charged to the fully charged state.

According to this control method, by controlling the plurality of converters, the plurality of battery assemblies can be charged to the fully charged state, and the equalization control for equalizing the voltages of the cells included in each battery assembly can be performed in the fully charged state.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing the overall configuration of a power supply system according to the present embodiment.

FIG. 2 is a diagram illustrating an example of an electrically powered vehicle.

FIG. 3 is a diagram showing an example of an equalization circuit included in a monitoring unit.

FIG. 4 is a diagram showing an example of a configuration of a controller of the power supply system.

FIG. 5 is a flowchart showing an example of processing of equalization control executed in the controller.

FIG. 6 is a diagram illustrating a controller of a power supply system according to a modified example.

### DESCRIPTION OF THE EMBODIMENTS

Hereinafter, embodiments of the present disclosure will be described in detail with reference to the accompanying drawings. In the drawings, the same or corresponding parts are denoted by the same reference numerals, and the description thereof will not be repeated.

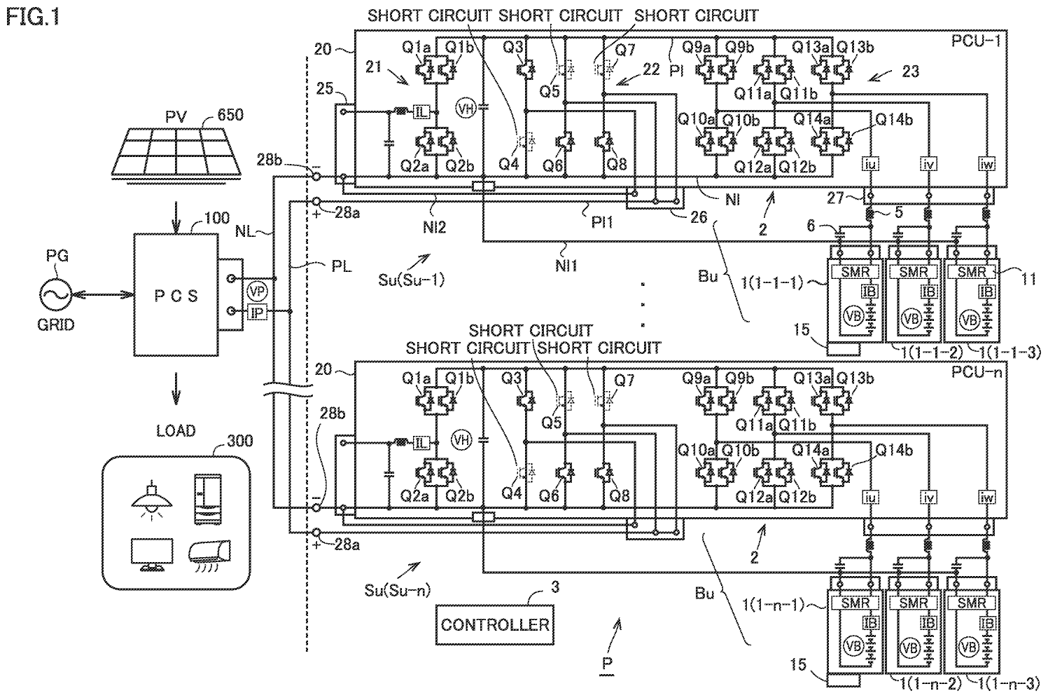

FIG. 1 is a diagram showing the overall configuration of a power supply system P according to the present embodiment. Referring to FIG. 1, power supply system P includes a plurality of power supply subunits Su and controller 3. Each of the plurality of power supply subunits Su includes three battery packs 1 and three converters 2. The power supply system P performs charging and discharging with an external system such as a PCS 100 (described later). In the present embodiment, the power supply subunit Su is used for the power supply system P from a battery pack and a power control unit (PCU) mounted on the electrically powered vehicle. Hereinafter, an example of a configuration of an electrically powered vehicle in which a battery pack and a PCU are mounted will be described.

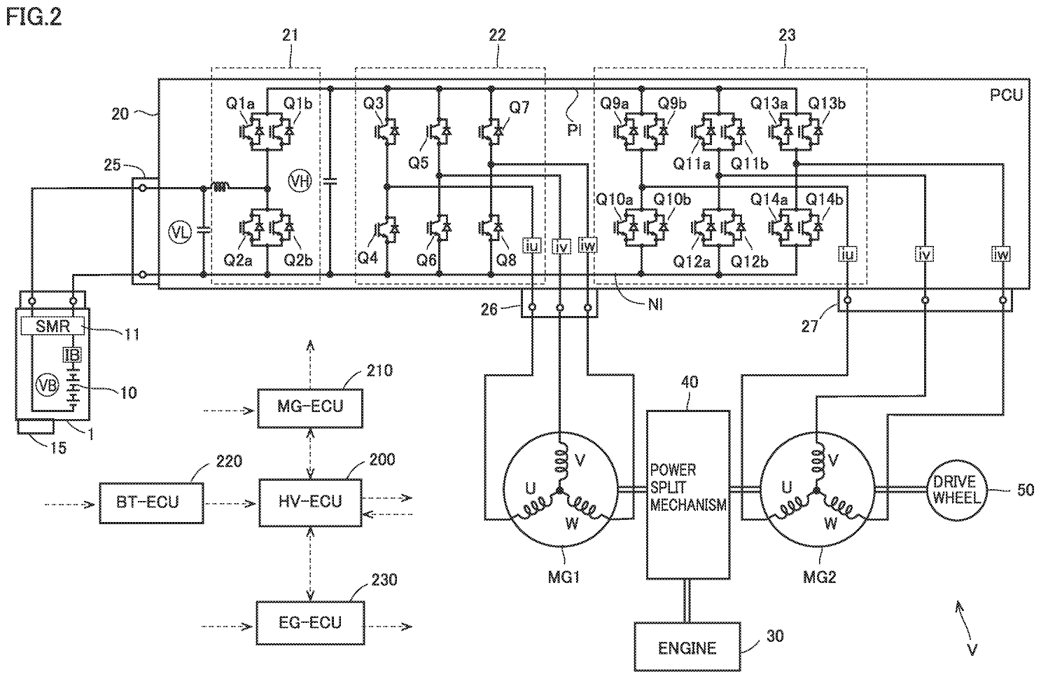

FIG. 2 is a diagram illustrating an example of an electrically powered vehicle. Referring to FIG. 2, electrically powered vehicle V is a hybrid electric vehicle that uses a rotary electric machine and an engine to drive the vehicle. Electrically powered vehicle V includes battery pack 1, PCU 20, engine 30, motor generators MG1 and MG2, power split mechanism 40, and drive wheels 50.

The battery pack 1 includes a battery 10 and a system main relay (SMR) 11. The battery 10 is a battery assembly including a plurality of single cells (battery cells). The plurality of cells are electrically connected in series. Each cell is composed of a secondary battery such as a nickel-metal hydride battery or a lithium ion battery. The output terminals (positive electrode terminal and negative electrode terminal) of the battery pack 1 are connected to the battery connection terminal 25 of the PCU 20. When the SMR 11 is closed, the battery 10 and the PCU 20 are connected to each other. When the SMR 11 is opened, the connection between the battery 10 and the PCU is interrupted. A monitoring unit 15 is attached to the battery pack 1. The monitoring unit 15 detects the voltage VB of the battery 10, the input/output current IB of the battery 10, and the temperature of the battery 10.

The PCU 20 includes a boost converter 21, an inverter 22, and an inverter 23. The boost converter 21 boosts the battery voltage VB input from the battery pack 1 and outputs the boosted voltage to the inverter 22 and the inverter 23. Inverter 22 converts the DC power boosted from boost converter 21 into three-phase AC power, and drives motor generator MG1, thereby starting engine 30. Inverter 22 converts AC power generated by motor generator MG1 into DC power using power transmitted from engine 30. The DC power is supplied to the boost converter 21. At this time, the boost converter 21 is controlled to operate as a step-down circuit. Inverter 23 converts the DC power output from boost converter 21 into three-phase AC power and outputs the three-phase AC power to motor generator MG2.

Power split mechanism 40 is coupled to engine 30 and motor generators MG1 and MG2 to distribute power therebetween. The power split mechanism 40 is, for example, a planetary gear mechanism. In this example, engine 30 is connected to the planetary carrier, motor generator MG1 is connected to the sun gear, and motor generator MG2 is connected to the ring gear. The rotor of motor generator MG2 (and the rotation shaft of the ring gear of power split mechanism 40) is coupled to drive wheel 50 via a reduction gear, a differential gear, and a drive shaft (all not shown).

The boost converter 21 of the PCU 20 includes a reactor and switching elements Q1a, Q1b, Q2a, and Q2b. Each of the switching elements Q1a to Q2b is, for example, an IGBT (Insulated Gate Bipolar Transistor) element. A corresponding diode is connected in antiparallel to the IGBT element. The switching element Q1a and the switching element Q1b are provided in parallel. The switching element Q2a and the switching element Q2b are provided in parallel. The switching element Q1a and the switching element Q1b are driven by the same driving signal. The switching element Q2a and the switching element Q2b are driven by the same driving signal.

The inverter 22 is a three-phase inverter and includes a U-phase arm, a V-phase arm, and a W-phase arm. The U-phase arm includes switching elements Q3 and Q4. The switching elements Q3 and Q4 are connected in series between the positive electrode line Pl and the negative electrode line Nl. The V-phase arm includes switching elements Q5 and Q6. The switching elements Q5 and Q6 are connected in series between the positive electrode line Pl and the negative electrode line Nl. The W-phase arm includes switching elements Q7 and Q8. The switching elements Q7 and Q8 are connected in series between the positive electrode line Pl and the negative electrode line Nl.

Like the switching element Q1a, each of the switching elements Q3 to Q8 is an IGBT element. Diodes are connected in antiparallel to the IGBT elements.

The intermediate point of each phase arm is connected to the corresponding phase coil of motor generator MG1 via MG1 connection terminal 26. Motor generator MG1 is a three-phase permanent magnet synchronous motor, such as an IPM (Interior Permanent Magnet) synchronous motor.

The configuration of the inverter 23 is the same as the configuration of the inverter 22 except that switching elements are provided in parallel in each arm of each phase. The switching elements Q9a and Q9b correspond to the switching element Q3. The switching elements Q10a and Q10b correspond to the switching element Q4. The switching elements Q9a, Q9b, Q10a, and Q10b are included in the U-phase arm of the inverter 23. The switching elements Q11a and Q11b correspond to the switching element Q5. The switching elements Q12a and Q12b correspond to the switching element Q6. The switching elements Q11a, Q11b, Q12a, and Q12b are included in the V-phase arm of the inverter 23. The switching elements Q13a and Q13b correspond to the switching element Q7. The switching elements Q14a and Q14b correspond to the switching element Q8. The switching elements Q13a, Q13b, Q14a, and Q14b are included in the W-phase arm of the inverter 23.

The intermediate point of each phase arm is connected to the corresponding phase coil of motor generator MG2 via MG2 connection terminal 27. Motor generator MG2 is, for example, an IPM synchronous motor.

The electrically powered vehicle V includes, as a controller, a hybrid ECU (Electronic Control Unit) (HV-ECU) 200, a motor-generator ECU (MG-ECU) 210, a battery ECU (BT-ECU) 220, and an engine ECU (EG-ECU) 230. Each ECU includes a CPU (Central Processing Unit), a memory, and a buffer (both not shown).

The monitoring unit 15 includes a voltage detection circuit and a current sensor. The voltage detection circuit detects the voltage (battery voltage) VB of the battery 10 and the cell voltage Vb. The current sensor detects an input/output current IB. The monitoring unit 15 further includes an equalization circuit (described later) that equalizes the voltages of cells of the battery 10. The BT-ECU 220 calculates the SOC of the battery 10 based on the voltage VB and the input/output current IB detected by the monitoring unit 15. The BT-ECU 220 transmits the calculated SOC value to the HV-ECU 200.

HV-ECU 200 sets target engine speed Ne, target engine torque Te, command torque Tm1 of motor generator MG1 and command torque Tm2 of motor generator MG2 for running control of electrically powered vehicle V.

MG-ECU 210 controls each switching element of inverter 22 by PWM (Pulse Width Modulation) so that command torque Tm1 is output from motor generator MG1. MG-ECU 210 controls each switching element of inverter 23 by PWM so that command torque Tm2 is output from motor generator MG2.

The EG-ECU 230 controls the engine 30 so that the engine 30 is operated at the target engine speed Ne and the target engine torque Te.

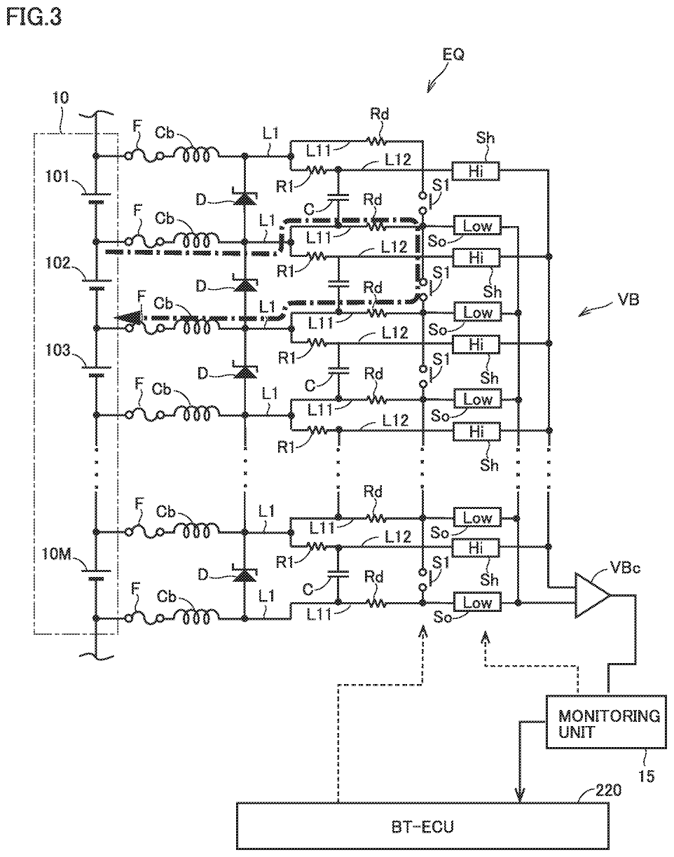

FIG. 3 is a diagram showing an example of an equalization circuit EQ included in the monitoring unit 15. The battery 10 includes a plurality of cells 101 to 10M connected in series. The voltage detection circuit VB detects the voltages of the cells 101 to 10M via a plurality of voltage detection lines L1, branch lines L11, and branch lines L12. A fuse F and chip beads Cb are provided in the voltage detection line L1 for circuit protection and the like. The plurality of Zener diodes D are provided in parallel with the cells 101 to 10M, respectively, and are provided to protect the voltage detection circuit VB from overvoltage.

The voltage detection line L1 branches into a branch line L11 and a branch line L12 from the Zener diode D to the monitoring unit 15 side. The branch line L11 is connected to the comparator 21a via a switch So. The branch line L12 is connected to the comparator 21a via a switch Sh. Each of the switch So and the switch Sh is, for example, a photo MOS (Metal Oxide Semiconductor) relay.

The branch line L12 is provided with a resistor R1. The branch line L12 is connected to the positive electrode terminal of the corresponding cell. The branch line L11 is connected to the negative electrode terminal of the corresponding cell. A capacitor (flying capacitor) C is provided between the branch lines L11 and L12. Thus, the monitoring unit 20 sequentially turns on the switches Sh and So corresponding to the cells 101 to 10M for each of the cells 101 to 10M, thereby detecting the cell voltage Vb using the voltage detection circuit VB by the flying capacitor method. By turning on (closing) the switch Sh of the cell 101 and the switch So connected to the negative electrode terminal of the cell 10M, the voltage VB of the battery 10 can be detected.

The equalization circuit EQ includes a plurality of discharge resistors Rd and a plurality of switches S1. Each discharge resistor Rd is provided in a corresponding branch line L11. Each of the switches S1 is provided to conduct (close)/block (open) between two adjacent branch lines L11. Each switch S1 is switched between ON (closed) and OFF (open) by receiving a control signal from the BT-ECU 220. When the cell voltage Vb of the cell 102 is higher than the cell reference voltage, the switch S1 corresponding to the cell 102 is turned on (closed). Then, the electric current discharged from the cell 102 is consumed by the discharge resistors Rd and Rd, as indicated by the arrows of the one-dot chain line. Thereby, the cell voltage Vb of the cell 102 decreases, and the cell voltage is equalized. In this way, the voltages of the battery cells of the battery 10 (battery assembly) is equalized.

Referring again to FIG. 1, in a power supply system P, each battery pack 1 and each converter 2 are inverted from a battery pack 1 and a PCU 20 (three-phase inverter) mounted on an electrically powered vehicle V. The positive electrode terminal of the output terminal of the three battery packs 1 (1-1-1, 1-1-2 and 1-1-3) is connected to the MG2 connection terminal 27 via the coil (inductor) 5. Intermediate points of respective phase arms (U-phase arm, V-phase arm, and W-phase arm) of the inverter 23 (three-phase inverter) of the PCU 20 are connected to the MG2 connection terminal 27. The power line between the positive electrode terminal of the battery pack 1 and the coil 5 is connected to the negative electrode terminal of the output terminal of the battery pack 1 via the capacitor 6. The negative electrode terminal of the battery pack 1 is connected to the negative electrode line Nl of the PCU 20 via the power line Nl1. In FIG. 1, for the sake of convenience, a part of the monitoring unit 15 is not shown.

As shown in FIG. 1, the switching element Q4, the switching element Q5, and the switching element Q7 of the inverter 22 of the PCU 20 are short-circuited. An intermediate point of each phase arm of the inverter 22 is connected to the MG1 connection terminal 26. The MG1 connection terminal 26 includes a terminal connected to the U-phase arm of the inverter 22. This terminal is connected to the negative electrode terminal of the battery connection terminal 25 via the power line Nl2. The negative electrode terminal of the battery connection terminal 25 is connected to the negative electrode terminal 28b of the power supply subunit Su. The MG1 connection terminal 26 includes terminals connected to the V-phase arm and the W-phase arm. The terminal is connected to the positive electrode terminal 28a of the power supply subunit Su via the power line Pl1.

The battery pack 1 is connected to each phase arm of the inverter 23 of the PCU 20. Some switching elements of the inverter 22 are short-circuited. The MG1 connection terminal 26 is connected to the positive electrode terminal 28a and the negative electrode terminal 28b of the power supply subunit Su. Thus, the PCU 20 is transferred to the converter 2. The converter 2 controls the voltage of the corresponding battery pack 1 (battery 10). The battery pack 1 is connected to an arm of a corresponding phase of the inverter 23. From another viewpoint, the battery 10 corresponding to the converter 2 among the plurality of batteries 10 is connected to each phase arm of the inverter 23.

In FIG. 1, the battery pack 1 or the battery 10 included in the battery pack 1 corresponds to an example of the “battery assembly” of the present disclosure. A chopper circuit composed of a phase arm (connected to one battery pack 1) corresponding to one battery pack 1, a coil 5, and a capacitor 6 corresponds to a “converter” of the present disclosure. For example, the U-phase arms (the switching elements Q9a, Q9b, Q10a, Q10b) of the inverter 23 and the chopper circuit (including the coil 5 and the capacitor 6) connected to the battery pack 1-1-1 form an example of the converter 2. The V-phase arms (the switching elements Q11a, Q11b, Q12a, Q12b) and the chopper circuit connected to the battery pack 1-1-2 form an example of the converter 2. The W-phase arms (the switching elements Q13a, Q13b, Q14a, Q14b) and the chopper circuit connected to the battery pack 1-1-3 form an example of the converter 2. In the example of FIG. 1, for the sake of convenience, three converters are collectively denoted by reference numeral 2. The battery pack 1 and a corresponding converter 2 (i.e., a converter 2 connected to the battery pack 1) correspond to the “battery unit” of the present disclosure. In one example, the converter 2 (the U-phase arm of the inverter 23) including the switching elements Q9a, Q9b, Q10a, and Q10b corresponds to (connected to) the battery pack 1-1-1 of the battery pack 1-1-1, 1-1-2 and 1-1-3. Converter 2 (V-phase arm) including switching elements Q11a, Q11b, Q12a, and Q12b corresponds (connected) to battery pack 1-1-2 among battery packs 1-1-1, 1-1-2 and 1-1-3. Converter 2 (W-phase arm) including switching elements Q13a, Q13b, Q14a, and Q14b corresponds (connected) to battery pack 1-1-3 among battery packs 1-1-1, 1-1-2 and 1-1-3. For example, in FIG. 1, a battery pack 1-1-1, a U-phase arm (switching elements Q9a, Q9b, Q10a, Q10b), a coil 5 connected to an intermediate point of the U-phase arm, and a capacitor 6 provided on a power line between a positive electrode terminal of the battery pack 1-1-1 and the coil 5 correspond to a “battery unit” of the present disclosure. In the description of the present embodiment, the reference symbol Bu is used for each battery unit without distinguishing each battery unit.

The power supply subunit Su includes a plurality of (three in this example) battery units Bu. The plurality of battery units each include a plurality of battery packs 1 (batteries 10) and converters 2. In other words, each of the three battery units Bu includes a battery 10 and a converter 2, and each converter 2 is transferred from the PCU 20. In the power supply subunit Su, the three battery units Bu are connected in parallel to each other. The power supply system P includes a plurality of power supply subunits Su. The plurality of power supply subunits Su are connected in parallel to each other with respect to PCS (Power Conditioning System) 100. The PCS 100 is provided outside the power supply system P. In the present embodiment, the plurality of power supply subunits Su are n power supply subunits Su. N is a positive integer, for example, 20. The power supply subunit Su includes three battery units Bu (battery pack 1) connected in parallel to each other. When the power supply system P includes 20 power supply subunits Su, the power supply system P includes 60 battery units Bu (battery pack 1) connected in parallel with each other. In FIG. 1, n in the symbol Su-n indicates that the target power supply subunit Su is the n-th power supply subunit Su. N in reference numerals 1-n-1, 1-n-2, and 1-n-3 represents that the target battery pack 1 is included in the n-th power supply subunit Su.

The positive electrode terminal 28a of each power supply subunit Su is connected to the input/output terminal of the PCS 100 via the positive electrode line Pl. The negative electrode terminal 28b of each power supply subunit Su is connected to the input/output terminal of the PCS 100 via the negative electrode line Nl.

The PCS 100 is connected to a power grid PG, a photovoltaic power generator 650, and a load (electric load) 300 in addition to the power supply system P. The power grid PG includes a power plant and a power transmission network, and is, for example, a commercial power supply. The PCS 100 includes a power converter. The power converter supplies power generated by the photovoltaic power generator 650 to the load 300 and performs reverse flow. The PCS 100 converts AC power of the power grid PG into DC power and charges the battery unit Bu (battery 10) of the power supply system P. The PCS 100 converts discharge power (output power) of the power supply system P (battery unit Bu) into AC power and supplies the AC power to the load 300 or performs reverse flow. The load 300 may be a household electric appliance or may be an electric load of a business or factory.

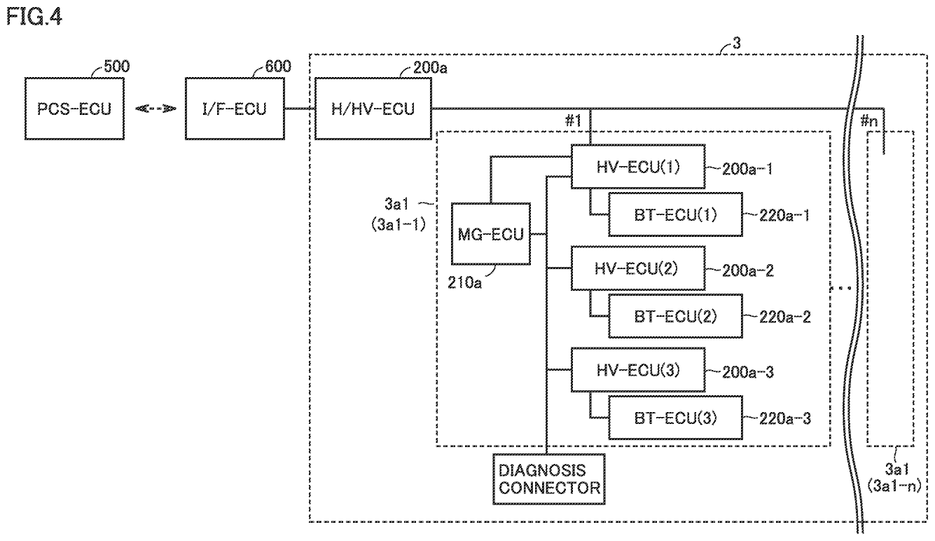

FIG. 4 is a diagram showing an example of the configuration of the controller 3 of the power supply system P. The controller 3 controls a plurality of battery units Bu (more specifically, the converter 2 and the SMR 11). The controller 3 includes an HV-ECU 200, an MG-ECU 210, and a BT-ECU 220 of the electrically powered vehicle V. Each of the H/HV-ECU 220a and HV-ECU (1) 220a-1 to HV-ECU (3) 220a-3 includes an HV-ECU 200. The MG-ECU 210a includes an MG-ECU 210. Each of the BT-ECUs 220a1 to 220a-3 includes a BT-ECU 220. Thus, various ECUs of the electrically powered vehicle can be effectively utilized for the power supply system P.

In FIG. 4, a PCS-ECU 500 is a controller that controls the PCS 100. The PCS-ECU 500 outputs a power command RP and a voltage command RV. The power command RP includes a power demand value output from the power supply system P (battery unit Bu) or a power demand value input to the power supply system P. The voltage command RV includes a command value of a voltage output from the power supply system P. An interface ECU (I/F-ECU) 600 interfaces between the PCS-ECU 500 and the controller 3 (H/HV-ECU 200a). The interface ECU 600 matches the communication protocol of the PCS-ECU 500 with the communication protocol of the controller 3. H/HV-ECU 200a receives power command RP and voltage command RV from PCS-ECU 500 via I/F-ECU 600, thereby generating power command RP and voltage command RV for each battery unit Bu. The H/HV-ECU 200a outputs a command for charge control of the battery unit Bu (battery 10).

Sub-controller 3a1 includes MG-ECU 210a, HV-ECU (1) 220a-1 to HV-ECU (3) 220a-3, and BT-ECUs 220a1 to 220a-3. The sub-controller 3a1 controls the power supply subunit Su. The sub-controller 3a1-1 controls the power supply subunit Su-1 (FIG. 1). The sub-controller 3a1 is provided for each power supply subunit Su. That is, the controller 3a includes n sub-controllers 3a1 including sub-controllers 3a1-1 to 3a1-n.

In FIG. 4, the BT-ECU (1) 220a-1 monitors the voltage VB, the input/output current IB, and the temperature of the battery 10 of the battery pack 1-1-1 of the power supply subunit Su-1, and performs equalization control of the battery pack 1-1-1. The BT-ECU (2) 220a-2 and the HV-ECU (3) 200a-3 perform similar processing on the battery pack 1-1-2 and the battery pack 1-1-3. The MG-ECU 210a controls the converter 2 based on a command from the H/HV-ECU 200a (drives switching elements of respective phase arms of the inverter 23).

The sub-controllers 3a1-2 to 3a1-n perform the same processing as the sub-controller 3a1-1 for the power supply subunits Su-2 to Su-n, respectively.

In the present embodiment, the battery pack 1 (battery 10) includes a battery assembly, and each cell of the battery assembly is a lithium ion battery. The type of lithium ion battery may be different for each battery pack 1. One kind of lithium ion battery is an iron-phosphate-based lithium ion battery (LFP battery). Other types of lithium ion batteries include ternary lithium ion batteries, manganese-based lithium ion batteries, or NCA-based lithium ion batteries.

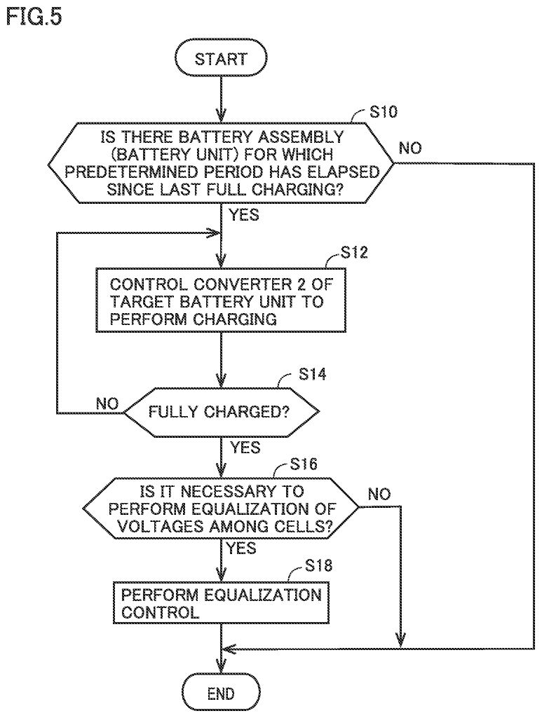

FIG. 5 is a flowchart showing an example of processing of equalization control executed by the controller 3. This flowchart is repeatedly executed every predetermined time during the operation of the power supply system P. Hereinafter, the step is abbreviated as “S”. In S10, the H/HV-ECU 200a determines whether or not a target battery unit exists. The target battery unit is the battery unit Bu (battery 10) after a predetermined period α has elapsed from the last full charge. The predetermined period α is set, for example, based on the variation of the amount of self-discharge of the single battery (cell) or the variation of the impedance of the voltage detection circuit VB. The predetermined period α may be, for example, 30 days. The H/HV-ECU 200a may determine that a predetermined period α has elapsed from the last full charge when the operation time of the battery unit Bu (battery 10) exceeds 1000 hours after the battery unit Bu has been charged to the full charge state the last time. The process of S10 corresponds to a process of determining whether or not the plurality of battery units Bu include at least one target battery unit.

When the target battery unit does not exist (NO in S10), the current routine ends. When the target battery unit exists (Yes in S10), the process proceeds to S12.

In S12, the converter 2 of the target battery unit is controlled to charge the battery pack 1 (battery 10) of the target battery unit. The target battery unit may be charged by power supplied from the power grid PG, or may be charged by power supplied from other battery units Bu.

Subsequently, in S14, the H/HV-ECU 200a determines whether or not the target battery unit has been charged to the fully charged state. In S12, the H/HV-ECU 200a charges the battery 10 by CV (Content Voltage) charging immediately before the battery 10 of the target battery unit is fully charged. For example, the H/HV-ECU 200a starts charging the battery 10 by charging CCCV (Constant Current, Constant Voltage), and charges the battery 10 with a constant current until the battery 10 reaches a predetermined voltage. After the voltage VB of the battery 10 reaches a specified value, the H/HV-ECU 200a charges the battery 10 with a constant voltage. In S14, the H/HV-ECU 200a determines that the battery 10 has been charged to the fully charged state when the charge current becomes equal to or less than the set value during the CV charge. The charging method is not limited to CCCV charging, and may be CPCV (Constant Power, Constant Voltage) charging, or may be a method of charging the battery 10 by CV charging from the start of charging.

When the charging current is equal to or less than the set value and it is determined that all the target battery units have been charged to the fully charged state (Yes in S14), the process proceeds to S16. When the full charge of all the target battery units is not completed (NO in S14), the process returns to S12. Thereafter, S12 is executed until the full charge of all the target battery units (battery 10) is completed. That is, the H/HV-ECU 200a controls the plurality of converters 2 so as to charge each of the plurality of batteries 10 to a fully charged state.

In S16, the controller 3 (BT-ECU (1) 220a-1 to BT-ECU (3) 220a-3 determines whether or not to equalize the voltages of the cells (cell voltages) of the battery 10 included in each of the target battery units. Hereinafter, the battery 10 included in the target battery unit is also referred to as a “target battery”. For example, when the deviation between the maximum value and the minimum value of the cell voltage Vb of the target battery is equal to or greater than the set value, the controller 3 determines that equalization of the cell voltages of the target battery is required (Yes determination). Then, the processing proceeds to S18. When the deviation between the maximum value and the minimum value of the cell voltages Vb of the target battery is less than the set value, the controller 3 determines that the equalization of the cell voltages of the target battery is unnecessary (negative determination). When the controller 3 determines that equalization of the cell voltages of all the target batteries is unnecessary, the current routine ends.

In S18, the controller 3 performs equalization control of the voltages of the battery cells of the target battery. For example, the controller 3 stops the converter 2 of the battery unit Bu of the target battery determined to require equalization (the switching elements of the respective phase arms are turned off). Then, the controller 3 calculates an average of the cell voltages Vb excluding the maximum value and the minimum value of the cell voltages Vb of the target battery, and sets the average as the cell reference voltage. The controller 3 preferentially discharges the single cell having the cell voltage higher than the cell reference voltage (consumes current by the discharge resistors Rd and Rd), and performs equalization control of the voltages of the cells of the target battery. S18 corresponds to the control of equalizing the voltages of the cells of the battery 10 when the battery 10 is charged to the fully charged state for each of the plurality of batteries 10. When the equalization control of the voltages between the cells of all the target batteries, which is determined to require equalization, ends, the current routine ends. Thus, for each of the plurality of batteries 10, the controller 3 controls the converter 2 corresponding to (connected to) the battery 10 among the plurality of converters 2 so that the battery 10 is charged to the fully charged state every time the predetermined period α has elapsed since the battery 10 was charged to the fully charged state the last time.

According to the present embodiment, the plurality of battery units Bu each include a plurality of batteries 10 (battery assembly) and converters 2. The plurality of battery units Bu are connected in parallel to each other. Since each battery unit Bu includes the battery 10 and the converter 2, the corresponding battery 10 (battery unit Bu) can be charged to a fully charged state by controlling the converter 2. The controller 3 performs equalization control for equalizing the voltage of the cells of the battery 10 (battery assembly) charged to the fully charged state (S18). Thus, the battery can be charged to the fully charged state, and the equalization control for equalizing the voltage of the cells of the battery 10 in the fully charged state can be executed.

The battery pack 1 (battery 10) of the present embodiment is composed of a plurality of types of lithium ion batteries. These lithium ion batteries also include LFP batteries. In particular, when each cell of the battery 10 is a LFP battery, by charging the battery 10 to a fully charged state and equalizing the voltage of the cell of the battery 10 in the fully charged state, the voltage of the cell can be equalized not in the voltage flat region of the OCV-SOC characteristic but in the voltage gradient region. As a result, the SOC variation among the cells can be effectively eliminated.

According to the above embodiment, the converter 2 of the battery unit Bu is inverted from the inverter 23 (three-phase inverter) included in the PCU 20 of the electrically powered vehicle V. The battery pack 1 of the electrically powered vehicle V is used as the battery pack 1 of the battery unit Bu. Therefore, it is possible to promote reuse of the battery and the PCU that are collected in association with buying, disassembling, and the like of the electrically powered vehicle V.

### Modified Example

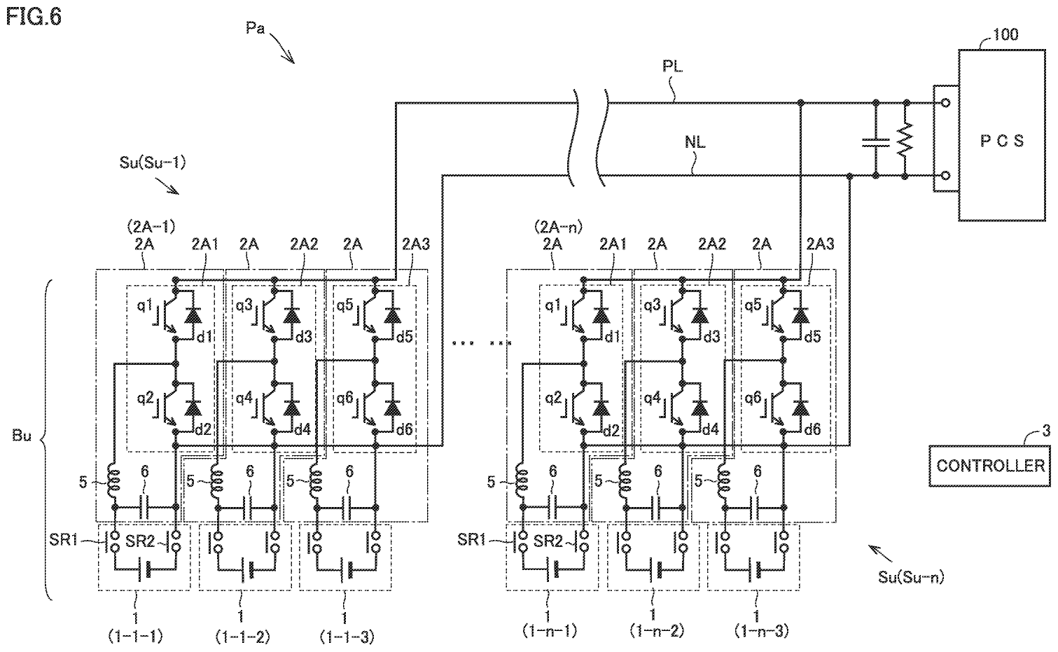

FIG. 6 is a diagram showing the overall configuration of a power supply system Pa according to a modified example. In the above embodiment, the PCU 20 includes the boost converter 21, the inverter 22, and the inverter 23, and is connected to the converter 2 of the power supply system P. In the above-described embodiment, two switching elements of the inverter 23 arranged in parallel to each other are used as switching elements of the converter 2 so that large electric power can pass therethrough. However, the PCU mounted on the electrically powered vehicle may include only one inverter or may not include any boost converter.

The converter 2A of the power supply system Pa in the modified example is switched from a PCU including a single inverter or from a circuit in which the inverter portion is extracted from the PCU.

Referring to FIG. 6, for each of a plurality of converters 2A, converter 2A is inverted from an inverter (three-phase inverter) of a PCU mounted on an electrically powered vehicle. SR1 and SR2 of the battery pack 1 are system main relays (SMR). As in the above embodiment, the positive electrode terminal of the output terminal of the three battery packs 1 (1-1-1, 1-1-2 and 1-1-3) is connected to the middle point of each phase arm (the U-phase arm 2A1, the V-phase arm 2A2, and the W-phase arm 2A3) of the three-phase inverter of the PCU via the coil (inductor) 5. The power line between the positive electrode terminal of the battery pack 1 and the coil 5 is connected to the negative electrode terminal of the output terminal of the battery pack 1 via the capacitor 6. The upper arms of the respective phase arms (the U-phase arm 2A1, the V-phase arm 2A2, and the W-phase arm 2A3) of the three-phase inverter are connected to the positive electrode line PL, and are connected to the input/output terminals of the PCS 100 through the positive electrode line PL. The lower arms of the respective phase arms (the U-phase arm 2A1, the V-phase arm 2A2, and the W-phase arm 2A3) of the three-phase inverter are connected to the negative electrode line NL, and are connected to the input/output terminals of the PCS 100 through the negative electrode line NL. The negative electrode terminal of the battery pack 1 is connected to the negative electrode line Nl. The monitoring unit 15 is not shown.

In the power supply system according to the above-described embodiments and modifications, the three-phase inverter is coupled to the converter. However, the converter included in the battery unit Bu may not necessarily be replaced by a three-phase inverter. The converter may include independent chopper circuits (converters) for each battery unit Bu.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power supply system that performs charging and discharging between the power supply system and an external system, the power supply system comprising:
a plurality of battery units including a plurality of battery assemblies and a plurality of converters provided corresponding to the plurality of battery assemblies; and
a controller that controls the plurality of battery units, wherein
the plurality of battery units are connected together in parallel, and
the controller controls the plurality of converters to charge each of the plurality of battery assemblies to a fully charged state, and
for each of the plurality of battery assemblies, the controller performs equalization control to equalize voltages of cells included in the battery assembly when the battery assembly is charged to the fully charged state.

2. The power supply system according to claim 1, wherein for each of the plurality of battery assemblies, the controller controls a converter of the plurality of converters that corresponds to the battery assembly so as to charge the battery assembly to the fully charged state whenever a predetermined period has elapsed since the battery assembly is charged to the fully charged state the last time.

3. The power supply system according to claim 1, wherein
the battery assembly includes a plurality of cells connected in series, and
each of the plurality of cells is an iron-phosphate-based lithium ion battery.

4. The power supply system according to claim 1, wherein
for each of the plurality of converters, the converter is diverted from a three-phase inverter, and
a battery assembly of the plurality of battery assemblies that corresponds to the converter is connected to each phase arm of the three-phase inverter.

5. A method of controlling a power supply system that performs charging and discharging between the power supply system and an external system, wherein
the power supply system includes a plurality of battery units including a plurality of battery assemblies and a plurality of converters provided corresponding to the plurality of battery assemblies, and the plurality of battery units are connected together in parallel,
the method comprising:
controlling the plurality of converters to charge each of the plurality of battery assemblies to a fully charged state; and
for each of the plurality of battery assemblies, performing equalization control to equalize voltages of cells included in the battery assembly when the battery assembly is charged to the fully charged state.
